(19) United States
(12) Patent Application Publication
(10) Pub. No.: US 2008/0083261 A1
(43) Pub. Date: Apr. 10, 2008

(54) Zero gravity scale adjusting device for a steel cylinder zero gravity detector

(76) Inventor: Li-Huan Chen, Fongshan City (TW)

Correspondence Address: Troxell Law Office PLLC, Suite 1404, 5205 Leesburg Pike, Falls Church, VA, 22041, US

(21) Appl. No.: 11/544,026

(22) Filed: Oct. 6, 2006

(51) Int. Cl. G01G 23/01; G01P 21/00; G01V 1/00

(52) U.S. Cl. 73/1.13; 73/1.38

(57) ABSTRACT

A zero gravity scale adjusting device for a steel cylinder zero gravity detector is composed of a main body, a suspension rod, a connector, a clamping device, and a counterweight, wherein the main body is extended with the suspension rod which is fixed on the connector, and the connector is corresponding to the clamping device which is extended with a fixing rod for rotatably fixing the connector. By rotatably fixing with the fixing rod, and through a scale of the clamping device, a position of the counterweight can be clearly and accurately adjusted while the device is used, and the counterweight can be quickly adjusted to achieve the balance position which can be detected conveniently.

### BACKGROUND OF THE INVENTION

(a) Field of the Invention

The present invention relates to a zero gravity scale adjusting device for a steel cylinder zero gravity detector, and more particularly to a device which uses the lever principle and a mutual association of a connector and a clamping device, as well as an installation of a scale, to directly adjust a relative position of the clamping device with respect to the connector.

(b) Description of the Prior Art

Referring to FIG. 1, a conventional zero gravity detector A is composed of a counterweight A1 on a suspension rod A2. As in adjusting for balance, a position of the counterweight A1 should be slowly turned and adjusted to achieve a purpose of adjusting for balance, and in addition, as an actual weight of a steel cylinder is not known; therefore, it will usually cause an inconvenience to a user and waste manpower. On the other hand, as the steel cylinder is too heavy, it will be more difficult to keep balance in adjusting for balance. Accordingly, these are the common problems to be complained by the user.

Therefore, how to eliminate the aforementioned problems is a technical issue to be solved by the present inventor.

### SUMMARY OF THE INVENTION

The primary object of present invention is to provide a zero gravity scale adjusting device for a steel cylinder zero gravity detector which uses the lever principle and a mutual association of a connector and a clamping device, as well as an installation of a scale, to directly adjust a relative position of the clamping device with respect to the connector, such that the entire body can be adjusted to a balance state, thereby achieving a quick adjustment and facilitating a detection.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional zero gravity detector.

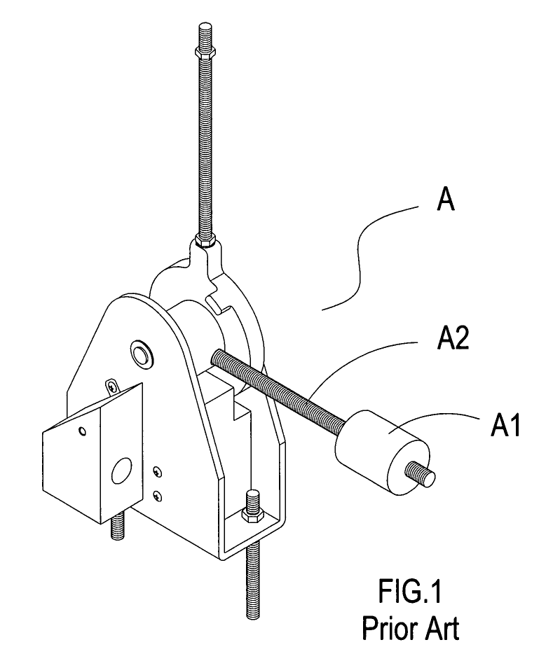

FIG. 2 shows a perspective view of the present invention.

FIG. 3 shows an exploded view of the present invention.

FIG. 4 shows a local exploded view of the present invention.

FIG. 5 shows a schematic view of an embodiment of the present invention.

FIG. 6 shows a second schematic view of an embodiment of the present invention.

FIG. 7 shows a third schematic view of an embodiment of the present invention.

### DETAILED DESCRIPTION OF THE PREFERRED EMBODIMENTS

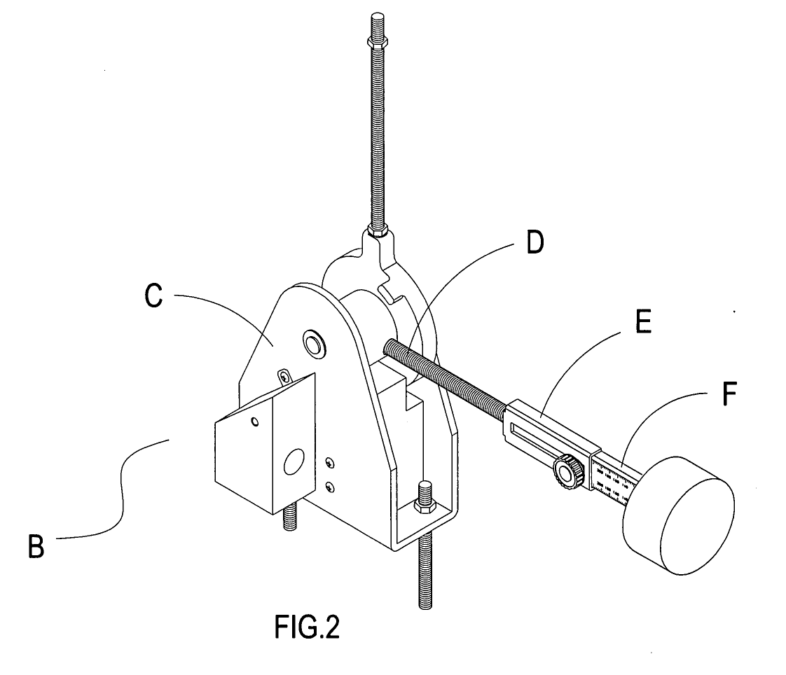

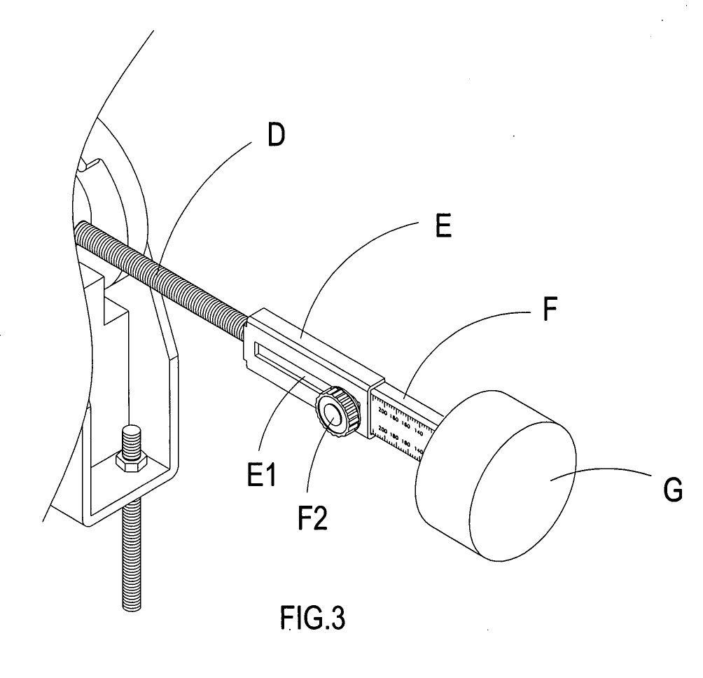

Referring to FIGS. 2 to 4, a zero gravity detector B comprises a main body C, a suspension rod D, a connector E, a clamping device F, and a counterweight G.

The main body C is extended with the suspension rod D which is latched with the connector E. The connector E is transfixed with a sliding groove E1 which allows a fixing rod F2 of the clamping device F to move and to be fixed rotatably. The fixing rod F2 is latched with a female thread F3 which is corresponding to a male thread F1 latched on the clamping device F. In addition, the clamping device F1 is additionally extended with the counterweight G. The clamping device F is provided with a scale F4, such that when a user moves the counterweight G which is extended from the clamping device F, he or she can clearly and accurately adjust a position, thereby allowing the user to more conveniently adjust for balance.

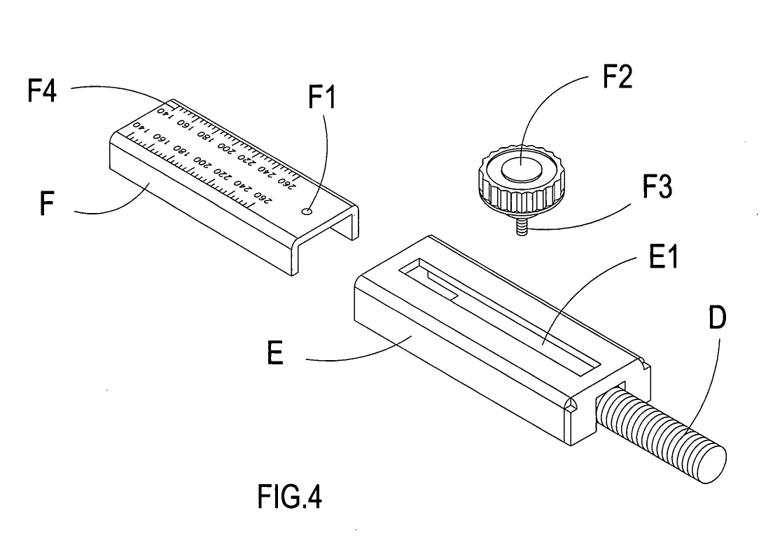

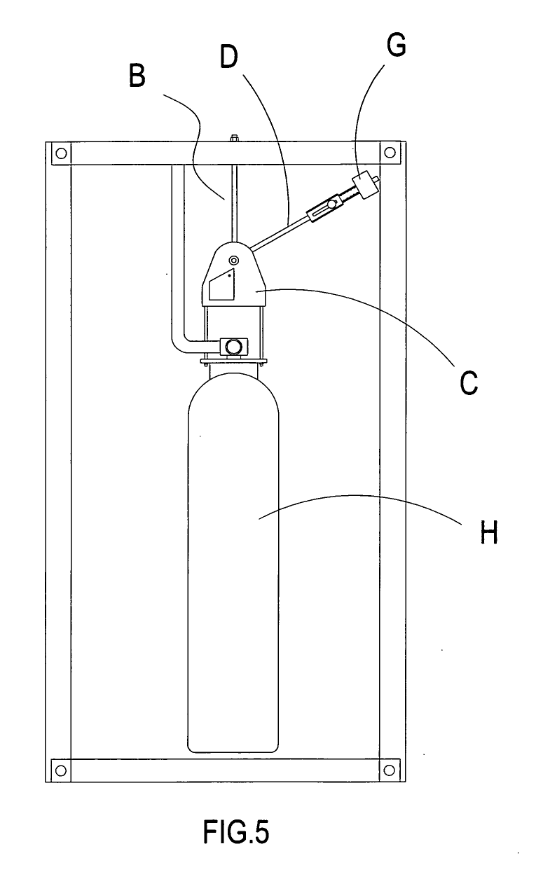

Referring to FIG. 4 and FIG. 5, when a lower part of the main body C is suspended with a steel cylinder H, the counterweight G can be adjusted to allow the zero gravity detector B to achieve a balance position, wherein the main body C is extended to the connector E through the suspension rod D, the connector E is corresponding to the clamping device F which is connected with the counterweight G, and the clamping device F is extended with the fixing rod F2. In addition, the clamping device F is transfixed with the male thread F1 which provides a robust screwing for the female thread F3 of the fixing rod F2. Moreover, through the scale F4 which is installed on the clamping device F, the user can clearly and accurately adjust the position in using the device.

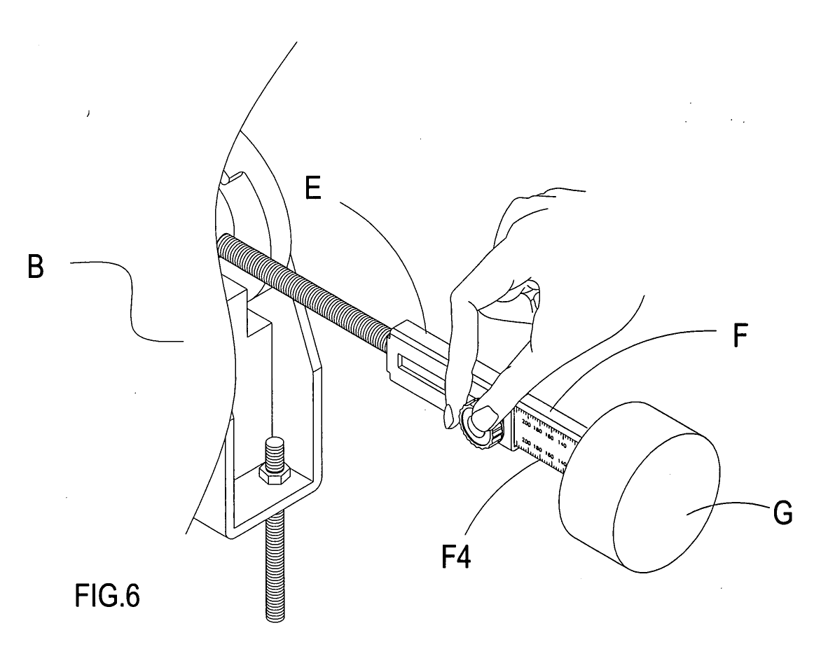

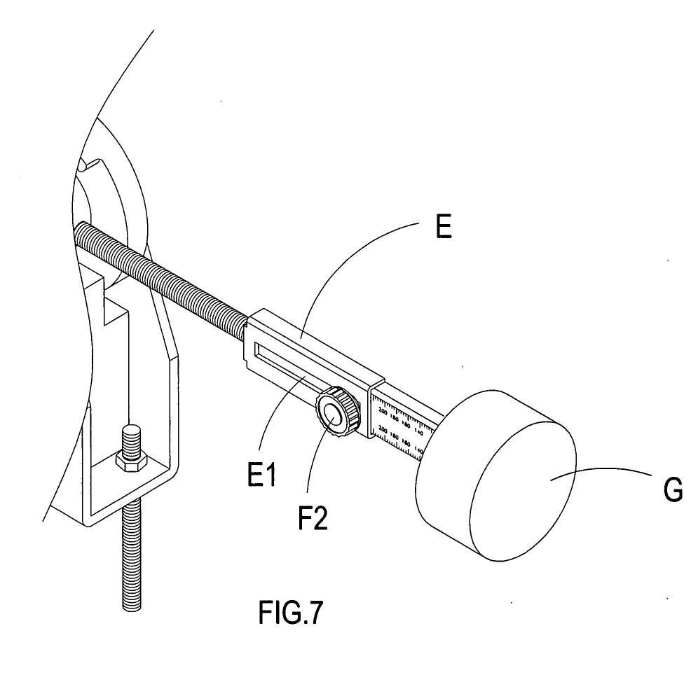

Referring to FIG. 6 and FIG. 7, when the position of counterweight G on the zero gravity detector B is to be adjusted, by moving forward or backward the scale F4 on the clamping device F to a required position, moving the fixing rod F2 of clamping device F to the sliding groove E1 of connector E, and fixing rotatably the fixing rod F2, the fixing rod F2 can be screwed to the clamping device F to tightly fix a relative position of the connector E between the clamping device F, thereby quickly adjusting the counterweight G to the balance position.

To further manifest the advancement and practicability of the present invention, the present invention is compared with a conventional zero gravity detector as follow.

Shortcomings of a Conventional Zero Gravity Detector
1. In adjusting for balance, the suspension rod should be slowly turned and adjusted, and the actual weight of steel cylinder cannot be known.
2. According to item 1, it will cause a waste in time.
3. As the steel cylinder is too heavy, it is more difficult to adjust for balance.

Advantages of the Present Invention
1. It can be quickly adjusted to allow the steel cylinder and the counterweight to achieve balance.
2. It can solve the problem that the steel cylinder is too heavy, to save time and to reduce the problem that it is difficult to achieve balance.
3. The real weight of steel cylinder can be actually known.
4. According to item 3, the manpower can be saved to unload the actual weight of steel cylinder which is to be scaled.
5. According to item 4, it achieves the functions of manpower saving and safety surveillance.
6. It has the advancement and practicability.
7. It can improve an industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A zero gravity scale adjusting device for a steel cylinder zero gravity detector, comprising a main body, a suspension rod, a connector, a clamping device, and a counterweight, wherein the main body is extended with the suspension rod which is latched with the connector, and the connector is fixed on the suspension rod; the connector being corresponding to the clamping device which is extended with the counterweight, and the clamping device being provided with a scale, so as to facilitate a user to clearly and accurately measure a position of the counterweight and to adjust the position, when using the device.

2. The zero gravity scale adjusting device for a steel cylinder zero gravity detector according to claim 1, wherein the clamping device is further connected with a fixing rod, such that in moving the counterweight which is extended from the clamping device, the position of counterweight is conveniently adjusted by a movement of the fixing rod and an association with a scale meter of the clamping device.

3. The zero gravity scale adjusting device for a steel cylinder zero gravity detector according to claim 2, wherein the connector is further transfixed with a sliding groove which allows the fixing rod of clamping device to move and to be fixed rotatably.

4. The zero gravity scale adjusting device for a steel cylinder zero gravity detector according to claim 1, wherein the connector and the clamping device is further connected by a latching mechanism, a gear mechanism, a belt mechanism, and other related fixing device which is movable.
